(19) United States
(12) Patent Application Publication
(10) Pub. No.: US 2015/0144715 A1
(43) Pub. Date: May 28, 2015

(54) ATOMIZED SPRAYER

(71) Applicant: Zong Jing Investment, Inc., Taipei (TW)

(72) Inventors: Charlene Hsueh-Ling Wong, Taipei (TW); John CHEN, Taipei (TW); Chun-Liang Julian HSIA, Taipei (TW)

(73) Assignee: Zong Jing Investment, Inc., Taipei (TW)

(21) Appl. No.: 14/242,275

(22) Filed: Apr. 1, 2014

(30) Foreign Application Priority Data
Nov. 27, 2013 (TW) 102222250

(51) Int. Cl. B05B 7/24; A45D 44/00

(52) U.S. Cl. CPC B05B 7/2491; A45D 44/00
USPC 239/418

(57) ABSTRACT

An atomized sprayer includes a main body, a gas pump, a nozzle member and an atomizing portion. The nozzle member includes a nozzle body and a nozzle head. Accordingly, the atomized sprayer is applicable to an automatic makeup device. The makeup materials are directed into the atomized sprayer through the material entrance of the atomizing portion and then are atomized by the atomizing plate; thereafter the atomized makeup materials are sprayed out with the propelling of the gas pump. Consequently, the atomized sprayer can be moved, so that the makeup with expected effect can be applied on the user's face concretely. Additionally, the efficient distance, amount, shape, width, range or outline of the sprayed makeup materials can be adjusted so as to meet a user's requirements.

### CROSS-REFERENCES TO RELATED APPLICATIONS

This non-provisional application claims priority under 35 U.S.C. §119(a) on Patent Application No. 102222250 filed in Taiwan, R.O.C. on Nov. 27, 2013, the entire contents of which are hereby incorporated by reference.

### BACKGROUND

1. Technical Field

The present invention relates to an atomized sprayer, and particularly to an atomized sprayer for spraying cosmetic materials.

2. Related Art

It is human nature to strive for beauty; consequently, numerous cosmetics for customers have appeared. Nevertheless, to apply a proper facial makeup or an eye makeup, the user must practice the makeup skills repeatedly. Furthermore, drawing various eyebrow shapes, eye contours, eye lines, and eye shadows, etc., requires the purchase of many kinds of cosmetics and makeup tools. However, the difference in proficiency in the makeup technique and the wide range of cosmetics usually results in a difference between the effect of the makeup and the effect expected by the user.

As information technology continues to evolve, a simulation device for a trial color makeup or a care product is provided. In order to replace the practical trial makeup, the user may use a color-makeup device to simulate an effect of makeup on a screen of the color-makeup device. However, it is difficult for the user to reshow the makeup simulated on the screen of the color-makeup device. So far, some manufacturers are devoted to develop the automatic color-makeup device, so that the makeup with expected effect can be reproducibly applied on the user's face. In order to apply the makeup with expected effect on the user's face, a spraying device capable of controlling the output amount and the output direction is necessary. Additionally, in order to control the output amount precisely and make the outputted cosmetic material be put at expected positions, the outline of the outlet of the spray device is varied.

### SUMMARY

In view of this, the present invention provides an atomized sprayer including a main body, a gas pump, a nozzle member and an atomizing portion. The main body is approximately formed as elongated shaped and includes a first opening and a second opening formed at two ends thereof in which the first opening and the second opening are opposite to each other. The interior of the main body is hollowed and formed as an atomizing room communicating with the first opening and the second opening. The gas pump is connected to the first opening. The nozzle member includes a nozzle body and a nozzle head. The nozzle head is disposed at a sharp end of the nozzle body. One end of the nozzle body which is opposite to the sharp end is connected to the second opening of the main body. The atomizing portion is disposed at a lateral side of the main body and includes a material entrance, an atomizing plate and an atomizing outlet. The material entrance and the atomizing outlet are located at two sides of the atomizing plate, and the atomizing outlet communicates with the atomizing room.

Accordingly, the atomized sprayer is applicable to an automatic makeup device. The makeup materials are directed into the atomized sprayer through the material entrance of the atomizing portion and then are atomized by the atomizing plate; thereafter the atomized makeup materials are sprayed out with the propelling of the gas pump. Consequently, the atomized sprayer can be moved, so that the makeup with expected effect can be applied on the user's face concretely. Additionally, the efficient distance, amount, shape, width, range or outline of the sprayed makeup materials can be adjusted so as to meet user's requirements.

The detailed features and advantages of the disclosure are described below in great detail through the following embodiments, the content of the detailed description is sufficient for those skilled in the art to understand the technical content of the disclosure and to implement the disclosure there accordingly. Based upon the content of the specification, the claims, and the drawings, those skilled in the art can easily understand the relevant objectives and advantages of the disclosure.

### BRIEF DESCRIPTION OF THE DRAWINGS

The disclosure will become more fully understood from the detailed description given herein below for illustration only and thus not limitative of the disclosure, wherein:

FIG. 1 is a perspective view of an atomized sprayer of a first embodiment of the disclosure;

FIG. 2 is an exploded view of the atomized sprayer of the first embodiment of the disclosure;

FIG. 3 is a cross sectional view of the atomized sprayer of the first embodiment of the disclosure;

FIG. 4 is a partial see-through view of the atomized sprayer of the first embodiment of the disclosure;

FIG. 5 is a partial see-through view of an atomized sprayer of a second embodiment of the disclosure;

FIG. 6 is a partial see-through view of an atomized sprayer of a third embodiment of the disclosure;

FIG. 7 is a partial see-through view of an atomized sprayer of a fourth embodiment of the disclosure;

FIG. 8 is a partial see-through view of an atomized sprayer of a fifth embodiment of the disclosure; and

FIG. 9 is a partial see-through view of an atomized sprayer of a sixth embodiment of the disclosure.

### DETAILED DESCRIPTION

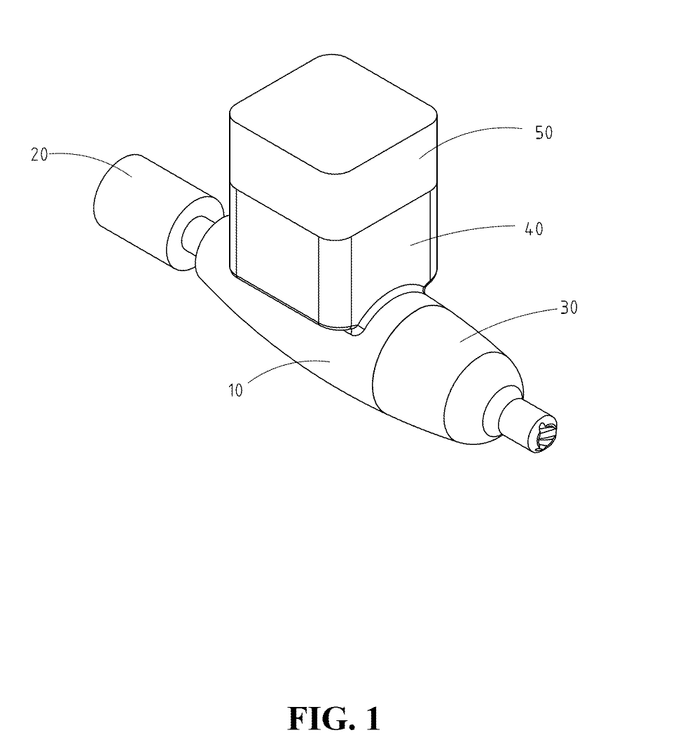

Please refer to FIGS. 1-4, which are respectively a perspective view, an exploded view, a cross sectional view and a partial see-through view of an atomized sprayer of a first embodiment. The atomized sprayer includes a main body 10, a gas pump 20, a nozzle member 30 and an atomizing portion 40. The main body 10 is approximately formed as elongated shaped and includes a first opening 11 and a second opening 12 formed at two ends thereof in which the first opening 11 and the second opening 12 are opposite to each other. In this embodiment, the outline of the main body 10 is formed as a halved rugby ball; that is, the diameter of the main body 10 is reduced gradually from one end near to the first opening 11 thereof toward the other end near to the second opening 12 thereof. The interior of the main body 10 is hollowed and formed as an atomizing room 13 communicating with the first opening 11 and the second opening 12.

The gas pump 20 is connected to the first opening 11. The gas pump 20 can be a micro-sized gas pump and directly connected to the first opening 11 of the main body 10. The outlet of the micro-sized gas pump communicates with the atomizing room 13 for providing the power to spray the atomized liquid. Alternatively, a detachable gas pump 20 is connected to the first opening 11 of the main body 10, when the main body 10 must be replaced, the gas pump 20 is not necessary to be replaced, the user only has to replace the main body 10, thereby a material wasting issue being prevented.

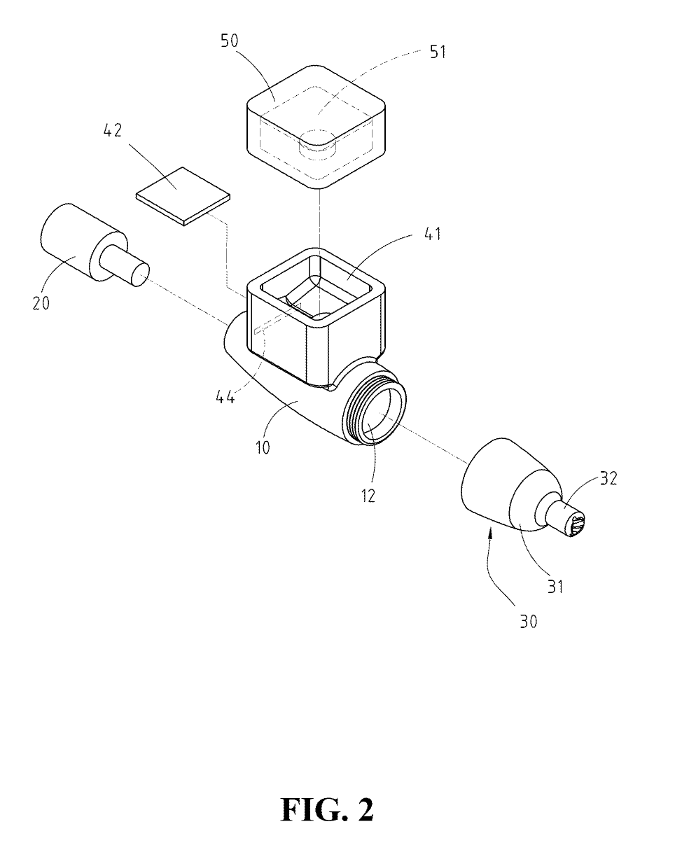

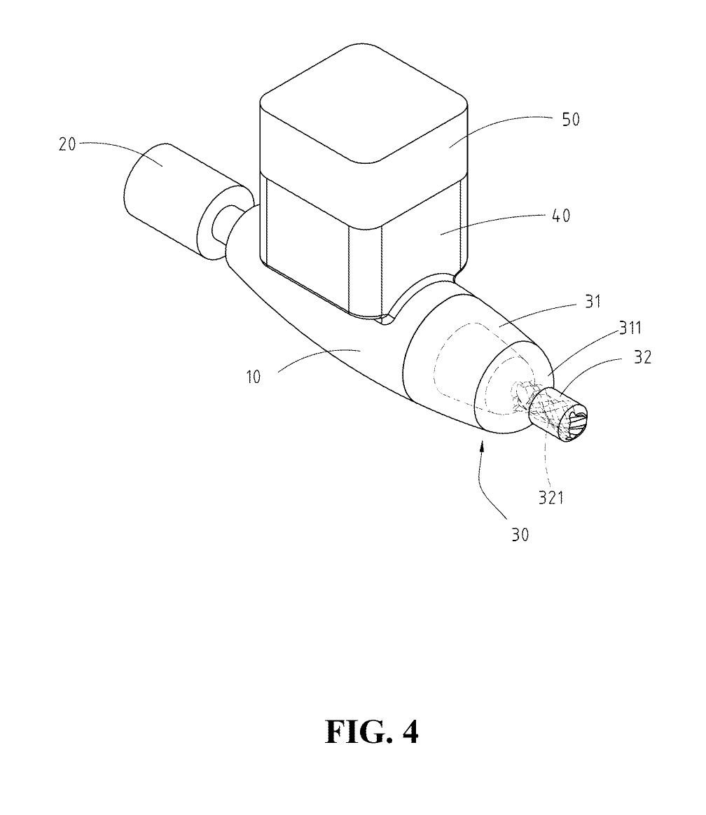

The nozzle member 30 includes a nozzle body 31 and a nozzle head 32. In this embodiment, the nozzle body 31 is formed as cone shaped and has a sharp end 311; but embodiments of the disclosure are not limited thereto, in some implementation aspects, the nozzle body 31 is oblate shaped, spiral shaped, rectangular shaped or formed as other geometric shapes. The nozzle head 32 is disposed at the sharp end 311 of the nozzle body 31. One end of the nozzle body 31 which is opposite to the sharp end 311 is connected to the second opening 12 of the main body 10. The connection between the nozzle body 31 and the second opening 12 is achieved by locking, buckling, or adhering, etc. As shown in FIG. 2 and FIG. 4, in this embodiment, the nozzle body 31 is connected to the second opening 12 of the main body 10 by threading with each other; that is, an inner threaded portion and an outer threaded portion are respectively disposed on the second opening 12 of the main body 10 and on one end of the nozzle body 31 opposite to the sharp end 311. Such connecting method provides an advantage of reducing the assembling procedures and reducing the number of the connecting components. Additionally, when the nozzle head 32 must be replaced with another, the nozzle head 32 can be directly detached from the main body 10; in some implementation aspects, the main body 10 and the nozzle member 30 are formed integrally as a whole, so that the main body 10 and the nozzle member 30 are formed as an inseparable structure.

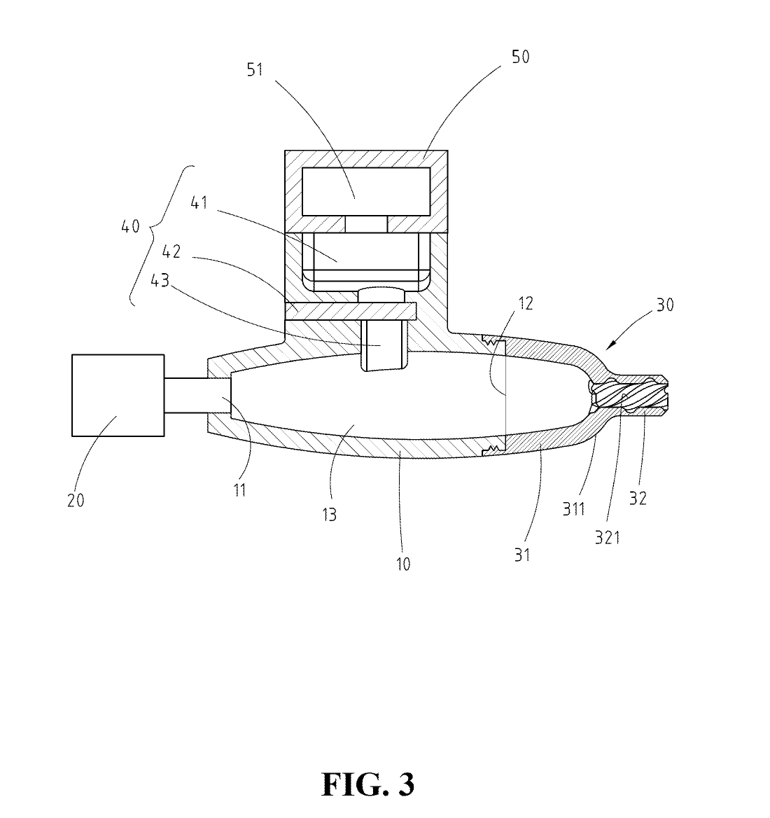

Please refer to FIG. 2 and FIG. 3, in which the atomizing portion 40 is disposed at a lateral side of the main body 10 and includes a material entrance 41, an atomizing plate 42 and an atomizing outlet 43. The material entrance 41 and the atomizing outlet 43 are respectively located at two sides of the atomizing plate 42, and the atomizing outlet 43 communicates with the atomizing room 13. In this embodiment, the atomizing portion 40 is formed as a rectangular cylinder with an aperture 44 opened at a lateral face thereon. The atomizing plate 42 is disposed in the atomizing portion 40 through the aperture 44. In some implementation aspects, the atomizing plate 42 can be securely assembled below the material entrance 41, rather than additionally defining the aperture 44 on the atomizing portion 40.

Upon the operation, the material entrance 41 is connected to a feeding device capable of providing makeup materials by means of material case, automatic feeding device, and material tank, etc. In this embodiment, the atomized sprayer has a material case 50. The interior of the material case SO is formed as a receiving space 51 for receiving the liquid makeup materials. The receiving space 51 is connected to the material entrance 41. The opening of the material case 50 faces toward the material entrance 41, so that the liquid makeup materials can be flowed into the material entrance 41. Furthermore, in this embodiment, in order to be connected with the material case 50 conveniently, the outline of the material entrance 41 is formed as rectangular shaped at the inlet thereof and turned into funnel-shaped toward the atomizing plate 42, so that the liquid makeup materials flowed from the material case 50 into the material entrance 41 are collected at the center of the material entrance 41 and flowed toward the atomizing plate 42.

Please refer to FIG. 2 and FIG. 4. As shown in FIG. 4, the nozzle head 32 is a hollowed circular tube and includes a plurality of rifling lines 321 at an inner wall thereof. Upon the operation, the liquid makeup materials are flowed out from the material case 50 and flowed into the material entrance 41; and then, the liquid makeup materials are collected at the atomizing plate 42 for atomization. The atomized makeup materials pass through the atomizing outlet 43 and enter into the atomizing room 13; thereafter, the gas pump 20 provides a propelling force for pushing the atomized makeup materials in the atomizing room 13 toward the nozzle head 32 and the nozzle body 31 with gradually reduced cross sectional area, thereby the atomized makeup materials passing through the nozzle head 32 and spraying onto the portions of the user's body to be makeup.

The rifling lines 321 disposed at the inner wall of the nozzle head 32 confines the region of the atomized makeup materials and limits the size of the sprayed spot, so that the atomized makeup materials can be sprayed out according to user's requirements. Additionally, based on the required efficient spraying distance, the length of the nozzle head 32 and the number of the rifling lines 321 can be adjusted, so that the atomized makeup materials can be sprayed to an expected distance. Based on this, the atomized sprayer is not closely attached to the portion of the user's body to be makeup, and the unintentional injuries raised from the movement of the user's body by using a contact-type makeup device can be prevented.

Accordingly, the atomized sprayer is applicable to an automatic makeup device. The propelling force provided by the gas pump 20 and the movement of the atomized sprayer are controlled by a controller of the automatic makeup device, so that the makeup with expected effect can be applied on the user's face concretely. Furthermore, through the controlling of the gas pump 20 and the disposing of the rifling lines 321 of the nozzle head 32, the amount of the makeup materials can be controlled precisely and the makeup material can be sprayed to an expected position.

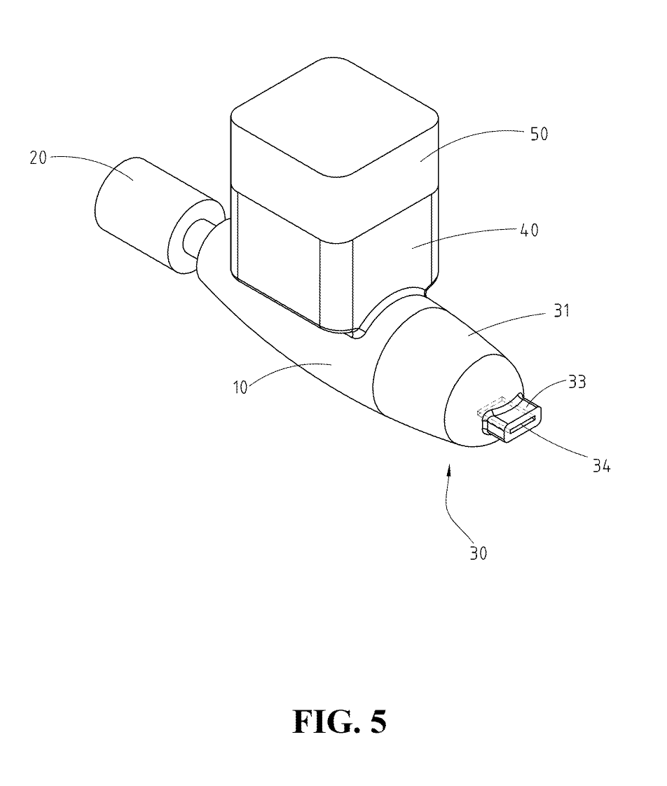

Please refer to FIG. 5, which is a partial see-through view of an atomized sprayer of a second embodiment of the disclosure. The structure of the atomized sprayer of the second embodiment is approximately similar to that of the first embodiment, except that the nozzle head 33 is a rectangular cylinder with an injecting channel 34 opened therethrough in this embodiment. To ensure the sprayed atomized makeup materials can draw linear shapes correctly, the cross section of the injecting channel 34 is rectangular. The width of the rectangular injecting channel 34 can be adjusted according to the width of the drawn lines, so that the amount and the size of the sprayed spot of the atomized makeup materials are adjusted.

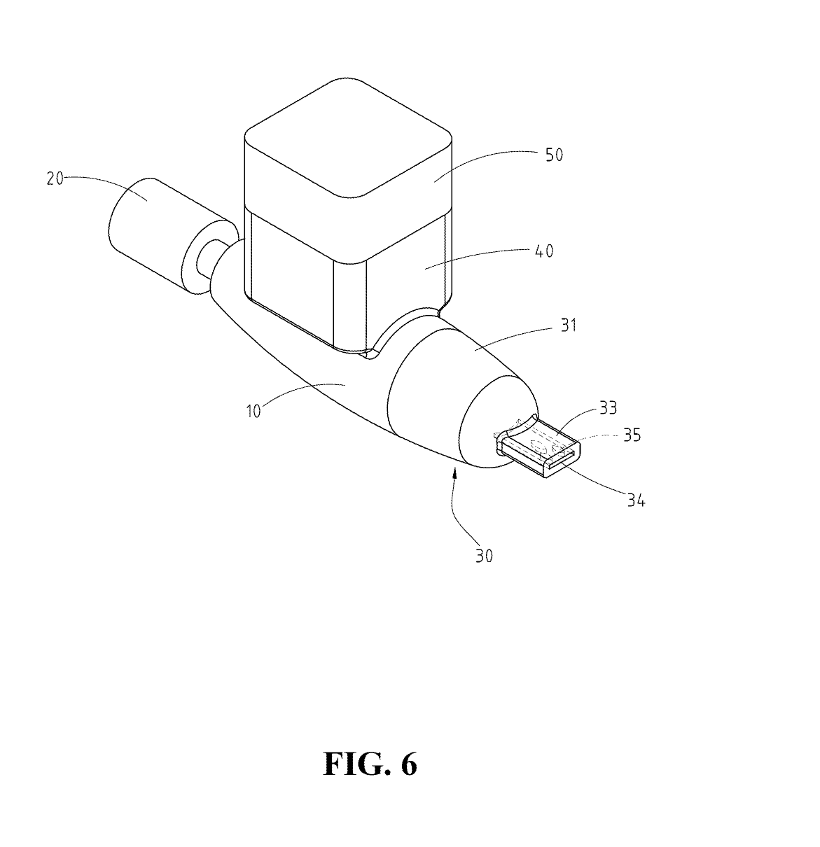

Please refer to FIG. 6, which is a partial see-through view of an atomized sprayer of a third embodiment of the disclosure. The structure of the third embodiment is approximately similar to that of the first embodiment, except that the nozzle head 33 is a rectangular cylinder with an injecting channel 24 opened therethrough in this embodiment. The nozzle head 33 includes three separating rods 35 formed as three elliptic cylinders; but embodiments are not limited thereto, the number of the separating rod 35 can be at least one or more and is depended on the required spraying conditions. Each separating rod 35 passes through the injecting channel 34 along a direction vertically to an axial direction of the injecting channel 34; as shown in FIG. 6, the three separating rods 35 pass through the injecting channel 34 in an up-to-down manner and form a triangle shape. The separating rods 35 are disposed for making the sprayed atomized makeup materials be proper to draw linear shapes and making the sprayed makeup materials formed as continuous spots. The number and the alignment of the separating rods 35 are also adjustable, so that the makeup with expected effect can be performed on the user's body.

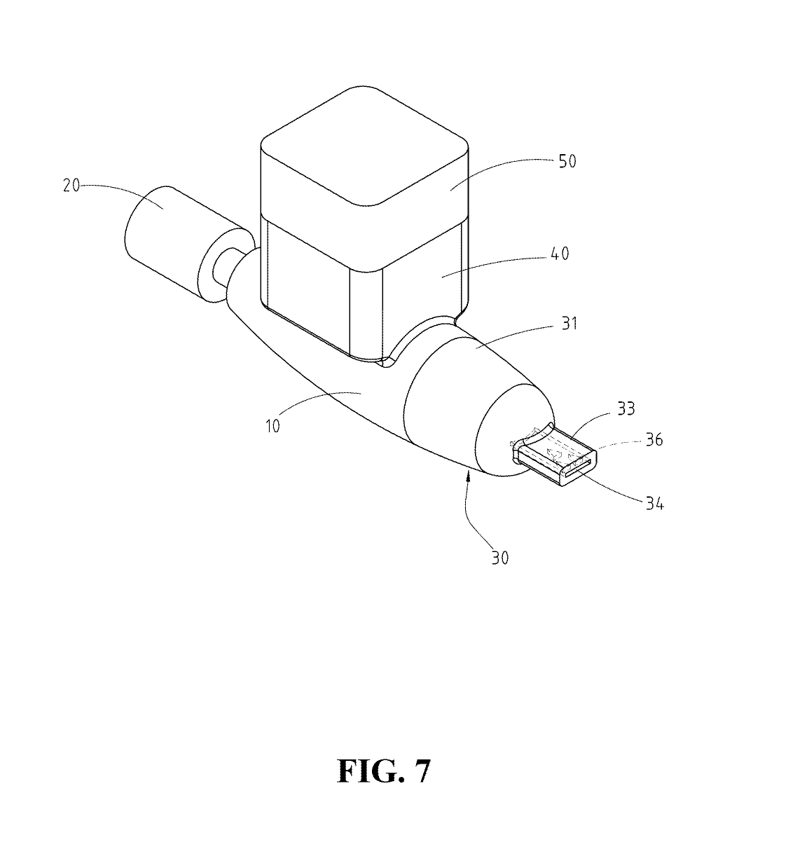

Please refer to FIG. 7, which is a see-through view of an atomized sprayer of a fourth embodiment of the disclosure. The structure of the fourth embodiment is approximately similar to that of the third embodiment, except that the separating rod 36 is a triangular cylinder in this embodiment. The outline of the separating rod 36 is changed, so that the atomized makeup materials are sprayed and aligned according to user's requirements and the makeup with expected effect can be performed.

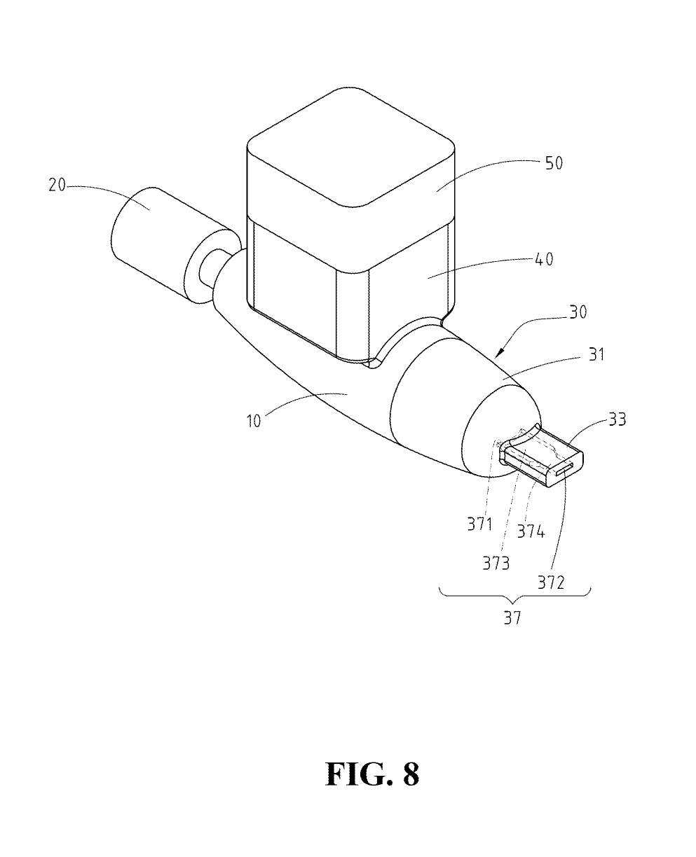

Please refer to FIG. 8, which is a partial see-through view of an atomized sprayer of a fifth embodiment of the disclosure. The structure of the fifth embodiment is approximately similar to that of the second embodiment, except that the injecting channel 37 includes a first end portion 373 and a second end portion 374 in this embodiment. The first end portion 373 is located at an entrance end 371 of the injecting channel 37. The second end portion 374 is located at an exit end 372 of the injecting channel 37. The cross sectional area of the first end portion 373 is larger than that of the second end portion 374. Besides, in this embodiment, the cross sections of the first end portion 373 and the second end portion 374 are both rectangular. Since the size of the injecting channel 37 is reduced gradually from the first end portion 373 toward the second end portion 374, the distance of the sprayed makeup materials can be adjusted, and the user does not need to apply the atomized sprayer in a close distance.

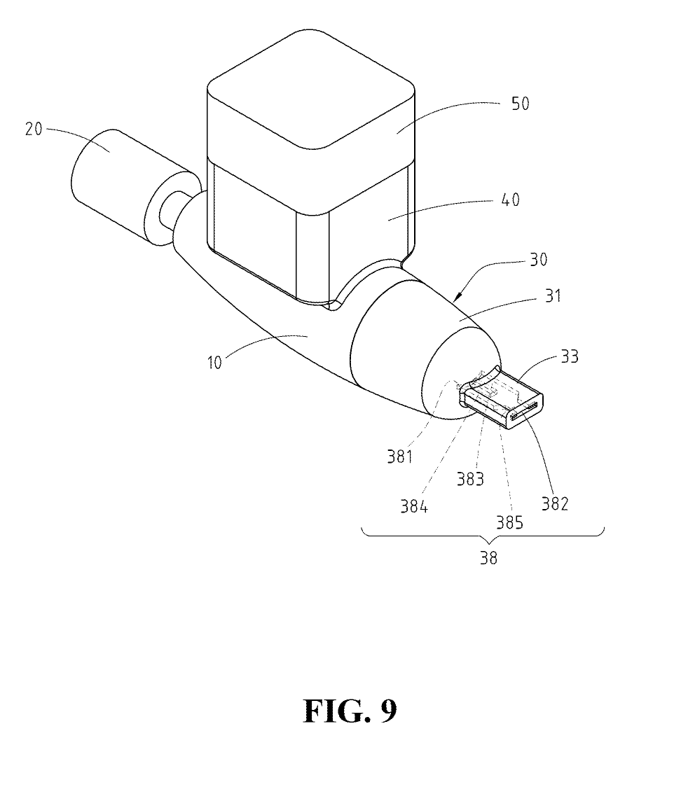

Please refer to FIG. 9, which is a partial see-through view of an atomized sprayer of a sixth embodiment of the disclosure. The structure of the sixth embodiment is approximately similar to that of the second embodiment, except that the injecting channel 38 includes a first channel 383, a second channel 384 and a third channel 385 in this embodiment. The first channel 383 and the second channel 384 are located at an entrance end 381 of the injecting channel 38. The third channel 385 is located at an exit end 382 of the injecting channel 38. The first channel 383 and the second channel 384 are parallel with each other and communicate with the third channel 385 individually. The makeup materials flowed into the entrance end 381 of the injecting channel 38 is divided into the first channel 383 and the second channel 384, and then recollected in the third channel 385 for spraying, so that the amount and the spray speed of the sprayed makeup materials can be fine tuned, thereby making the amount of the sprayed makeup materials be accurate as expected by the user; additionally, the issue of spraying a large amount of makeup materials at one time can be prevented.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An atomized sprayer, comprising:
a main body, approximately formed as elongated shape, comprising a first opening and a second opening formed at two ends thereof and opposite to each other, the interior of the main body being hollowed and formed as an atomizing room communicating with the first opening and the second opening;
a gas pump, connected to the first opening;
a nozzle member, comprising a nozzle body and a nozzle head, the nozzle head being disposed at a sharp end of the nozzle body, one end of the nozzle body opposite to the sharp end being connected to the second opening of the main body; and
an atomizing portion, disposed at a lateral side of the main body, the atomizing portion comprising a material entrance, an atomizing plate and an atomizing outlet, the material entrance and the atomizing outlet being located at two sides of the atomizing plate respectively, and the atomizing outlet communicating with the atomizing room.

2. The atomized sprayer according to claim 1, wherein the nozzle head is a hollowed circular tube comprising a plurality of rifling lines at an inner wall thereof.

3. The atomized sprayer according to claim 1, wherein the nozzle head is a rectangular cylinder with an injecting channel opened therethrough.

4. The atomized sprayer according to claim 3, wherein the cross section of the injecting channel is rectangular.

5. The atomized sprayer according to claim 4, wherein the nozzle head comprises at least one separating rod passing through the injecting channel along a direction vertically to an axial direction of the injecting channel.

6. The atomized sprayer according to claim 4, wherein the separating rod is an elliptic cylinder.

7. The atomized sprayer according to claim 4, wherein the separating rod is a triangular cylinder.

8. The atomized sprayer according to claim 3, wherein the injecting channel comprises a first end portion and a second end portion, the first end portion is located at an entrance end of the injecting channel and the second end portion is located at an exit end of the injecting channel, the cross sectional area of the first end portion is larger than that of the second end portion.

9. The atomized sprayer according to claim 8, wherein the cross sections of the first end portion and the second end portion are rectangular.

10. The atomized sprayer according to claim 3, wherein the injecting channel comprises a first channel, a second channel and a third channel, the first channel and the second channel are located at an entrance end of the injecting channel, the third channel is located at an exit end of the injecting channel, the first channel and the second channel are parallel with each other and communicate with the third channel individually.
